(19) United States
(12) Patent Application Publication
(10) Pub. No.: US 2017/0130733 A1
(43) Pub. Date: May 11, 2017

(54) METHOD FOR PREVENTING THE CORROSION OF AN IMPELLER-SHAFT ASSEMBLY OF A TURBOMACHINE

(71) Applicant: GENERAL ELECTRIC TECHNOLOGY GMBH, Baden (CH)

(72) Inventors: Filippo CAPPUCCINI, Florence (IT); Stefania STRAMARE, Florence (IT); Marco ROMANELLI, Florence (IT); Marco ANSELMI, Florence (IT); Riccardo PAOLETTI, Florence (IT); Alessio BANDINI, Florence (IT)

(21) Appl. No.: 15/310,943

(22) PCT Filed: May 13, 2015
(86) PCT No.: PCT/EP2015/060609

§ 371 Date: Nov. 14, 2016

(30) Foreign Application Priority Data
May 15, 2014 (IT) CO2014A000015

(51) Int. Cl. F04D 29/22; F04D 29/043; F04D 29/053; F04D 29/62; C25D 3/04; C23C 18/16; C23C 4/12; B05D 1/12; C23F 11/00; C25D 3/12; F04D 29/28; C23C 18/32

(52) U.S. Cl. CPC F04D 29/2294; F04D 29/28; F04D 29/043; F04D 29/053; F04D 29/624; F04D 29/628; C23C 18/32; C23C 18/1633; C23C 4/12; B05D 1/12; C23F 11/00; C25D 3/12; C25D 3/04

(57) ABSTRACT

A method for preventing corrosion of an impeller-shaft assembly of a turbomachine comprises the steps of assembling an impeller on a shaft in order to define an impeller-shaft assembly; plating the assembly by inserting the assembly into a plating bath; and coating at least a first predefined surface on the impeller and a second predefined surface on the shaft wherein the coating step is performed by spraying the predefined surfaces.

### DESCRIPTION

The present invention relates to a method for preventing the corrosion of an impeller-shaft assembly of a turbomachine. The method of the present invention can be advantageously used for preventing corrosion in a component of a subsea or onshore or offshore turbomachine. In the following disclosure reference will be made specifically to a centrifugal compressor for ease of description only; no limitation on the applicability of the present invention is however intended.

Materials like carbon steel, low-alloy steel and stainless steel are normally used when building components which operate in subsea or onshore or offshore environments. If such environments comprise wet carbon dioxide (CO2) and/or wet hydrogen sulfide (H2S), carbon steel and low-alloy steel will be affected by corrosion damages. Moreover, if such environments comprise chlorides, stainless steel will be affected by pitting corrosion damages.

A method for preventing the corrosion of an impeller-shaft assembly of a turbomachine is known in the art. Indeed, an impeller-shaft assembly of a turbomachine can be made of a corrosion resistant alloy, for example a stainless steel or nickel alloy. This is done when the turbomachine is intended to operate in a corrosive environment.

### SUMMARY

A disadvantage of the above described prior art is that it incurs into significant costs, as corrosion-resistant alloys are significantly more expensive than low-alloy steel.

A first aspect of the invention is therefore directed to a method for preventing corrosion of an impeller-shaft assembly of a turbomachine comprising the steps of assembling an impeller on a shaft in order to define an impeller-shaft assembly. A first predefined surface on the impeller and a second predefined surface on the shaft are coated. The assembly is plated after the coating step, by inserting it into a plating bath. Advantageously, this allows spraying or electroplating easily the surface that can be hard to reach when the impeller is assembled on the shaft.

Such method also has the advantage of allowing to build an impeller-shaft assembly for use in a corrosive environment without resorting to expensive alloys. Indeed, the pieces are coated by inserting them into a plating bath. The components are also coated onto surfaces which are, when assembled, inside gaps or other places that are difficult to reach by the plating solution inside the bath. Between the coating and the plating the entire assembly is thus protected from the corrosion, and can therefore be made from a low-alloy steel or carbon steel.

In another aspect of the invention, the step of plating is performed by electroless nickel plating. Advantageously, if the plating is performed on the entire assembly, as in the case in the above method, a degradation of the plating is prevented during assembly. Such degradation would happen if the plating were to be performed on the impeller and on the shaft separately, as one of them needs to be heated for the assembly step.

Further details and specific embodiments will refer to the attached drawings, in which:

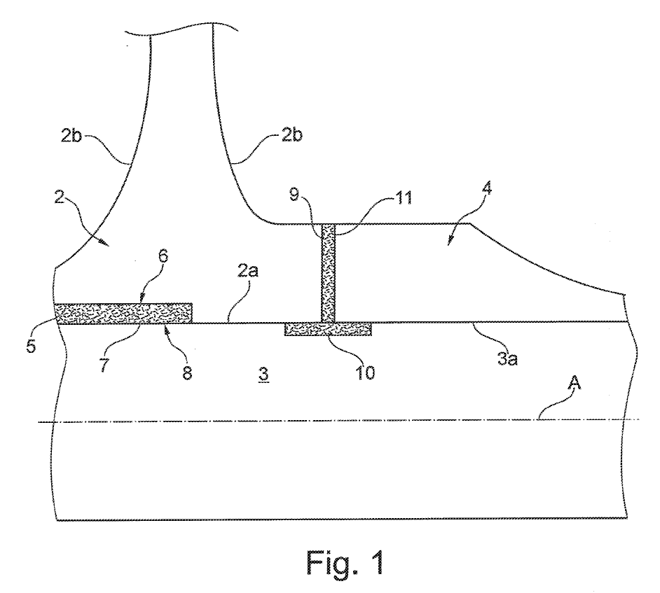

FIG. 1 is a schematic sectional lateral view of an impeller-shaft assembly according to an embodiment of the present invention; and

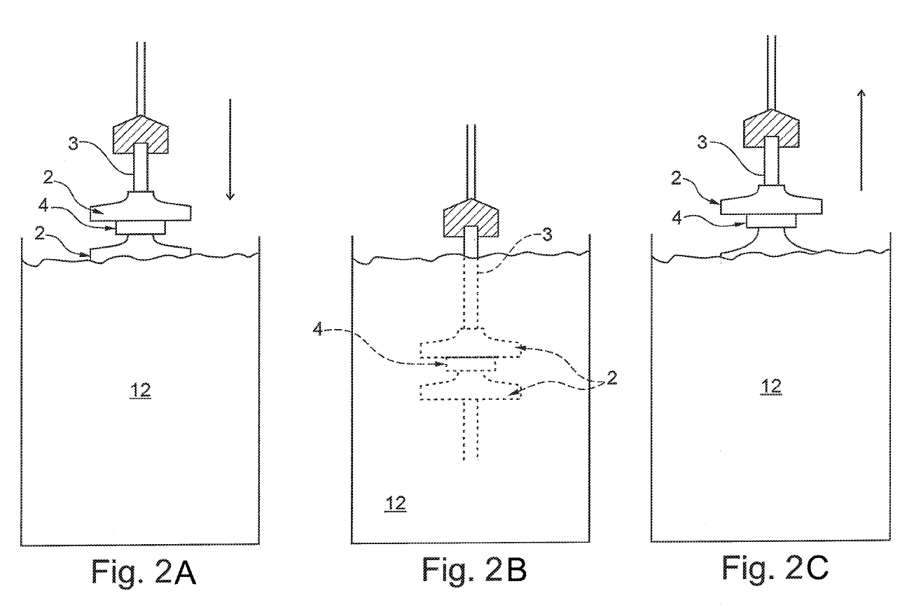

FIGS. 2a, 2b and 2c are schematic views of respective steps of a method for preventing corrosion of an impeller-shaft assembly according to an embodiment of the present invention.

### DETAILED DESCRIPTION

The following description of exemplary embodiments refer to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Therefore, a method for preventing corrosion of an impeller-shaft assembly of a turbomachine will be described by referring to the attached drawings, in which the impeller-shaft assembly will be referenced with the number 1.

The impeller-shaft assembly 1 comprises a shaft 3. The shaft is substantially cylindrical, and has a lateral surface 3a.

The impeller-shaft assembly 1 also comprises an impeller 2 mounted on the shaft 3. Specifically, the impeller 2 is coaxial with respect to the shaft 3. Therefore, the impeller-shaft assembly 1 has a central axis “A”, which defines an axis of rotation for the shaft 3 and for the impeller 2.

Additionally, the impeller 2 has an internal surface 2a which, in use, faces the shaft 3. Indeed, the greatest part of the internal surface 2a of the impeller 2 is actually in contact with the shaft 3. The impeller 2 also has an external surface 2b facing outwardly with respect to the shaft 3.

Both the internal 2a and the external surface 2b, in case of operation in a chemically aggressive environment, can be treated to prevent damage to the impeller 2 itself. Further details will be given in a following part of the present disclosure.

With additional detail, the impeller-shaft assembly 1 comprises a plurality of impellers 2. Between two consecutive impellers 2, the assembly 1 comprises a sleeve 4, which is attached to the shaft 3. According to the embodiment shown in FIG. 1, the central axis “A” of the shaft 3 can be regarded as an axis of symmetry of the sleeve 4.

An embodiment of the present invention therefore relates to a method for preventing corrosion of the impeller-shaft assembly 1. Such method comprises the steps of coating at least a first predefined surface 5 on said impeller 2. Such first predefined surface is preferably part of the internal surface 2a which faced the shaft. More preferably, the impeller 2 comprises a key slot 6 for reversibly attaching the impeller 2 itself to the shaft 3. The first predefined surface 5 is therefore the part of the internal surface 2a of the impeller 2 that defines the key slot 6.

A second predefined surface 7 is also coated in the same way as the first predefined surface 6. Preferably, the second predefined surface is part of the lateral surface 3a of the shaft 3. More preferably, the second predefined surface 7 is the surface of a key seat 8 which is configured to receive a key that is also inserted into the key slot 6 of the impeller 2 in order to attach the impeller 2 to the shaft 3.

According to the described embodiments of the invention, the step of coating the first 5 and the second predefined surface 7 is performed by spraying or electroplating them. In a preferred embodiment of the invention, the first 5 and second predefined surface 7 are sprayed with a cold spray. Such cold spray can for example comprise solid powders made from nickel-based alloys, cobalt based alloys or stainless steel.

Cold spraying acts by kinetic effect, meaning that the particles composing the spray can embed themselves in a layer of the predefined surfaces 5, 7 by means of their kinetic energy. Advantageously, this avoids any unwanted thermal treatment of the predefined surfaces 5, 7.

Alternatively, the step of coating the predefined surfaces 5, 7 can be performed by spraying them with a thermal spray. In this way, the temperature of the spray itself also treats the predefined surfaces 5, 7.

Alternatively, the step of coating the predefined surfaces 5, 7 can be performed by electroplating. The electroplating can be performed for example with electrolytic chromium or nickel.

If a sleeve 4 is to be included in the assembly 1, the step of coating may also comprises the coating a third predefined surface 9 on the impeller 2. Such third predefined surface 9 is a portion of the surface of the impeller 2 which, in operation, faces the sleeve 4.

The step of coating may also comprise the coating of a fourth predefined surface 10. Such fourth predefined surface 10 is also onto the shaft 3. Specifically, the fourth predefined surface 10 is a portion of the lateral surface 3a of the shaft 3 which overlaps the impeller 2 and the sleeve 4.

The step of coating may also comprise the step of coating a fifth predefined surface 11. Such fifth predefined surface is located on the sleeve 4, specifically on a surface of the sleeve 4 which faces the impeller 2. In other words, the third 9 and the fifth predefined surface 11 face each other. The fourth predefined surfaces 10 bridges the gap between the third 9 and the fifth predefined surfaces 11.

The coating of the third 9, fourth 10 and fifth predefined surface 11 is performed in the same manner as the coating of the first 5 and of the second predefined surface 7. Concerning the above described coating methods (cold spray, thermal spray or electroplating), they can be applied in whatever combination is suitable for the specific purpose. In other words, the coating of the first 5, second 7 third 9, fourth 10 and fifth predefined surface 11 can be performed all with the same specific coating method or with any combination of them.

After the coating step, the impeller 2 is assembled on the shaft 3. Specifically, the impeller 2 is locked onto the shaft 3 by inserting a key (not shown in the figures) in the key slot 6 of the impeller 2. The key is also placed onto the key seat 8 of the shaft 3. If a sleeve 4 is used it is also installed in this step, by locking it between two impellers 2. The above operations are repeated for each impeller 2 and sleeve 4 which have to be installed onto the shaft 3.

According to the preferred embodiment of the invention, the assembly 1 is then plated. Preferably, this is performed by inserting the assembly 1 into a plating bath and by pulling it out after a predefined time.

Preferably, the step of plating is performed by electroless nickel plating. Indeed, the step of plating comprises a first deposition sub-step, in which a first metallic layer is deposited on the assembly 1 substrate by electroplating. Afterwards, a second deposition step is performed, where at least a second layer of a nickel alloy is plated on the first layer by electroless plating. A thermal treatment step can then be performed after the deposition steps. The temperature and the duration of the thermal treatment depend on the overall thickness of the layers and on the final properties to be obtained.

Optionally, the plating step can include a third deposition step, in which a third metallic layer is deposited on the second layer by electroplating. A fourth deposition step of depositing a fourth layer of nickel alloy on the third layer by electroless plating can also optionally be performed.

What is claimed is:

1. A method for preventing corrosion of an impeller-shaft assembly of a turbomachine, the method comprising:
assembling an impeller on a shaft in order to define an impeller-shaft assembly;
plating the assembly by inserting the assembly into a plating bath; and
coating at least a first predefined surface on the impeller and a second predefined surface on the shaft,
wherein the coating step is performed before the assembling step.

2. The method according to claim 1, wherein the first predefined surface is a surface of a key slot on the impeller for attaching the impeller to the shaft.

3. The method according to claim 1, wherein the second predefined surface is the surface of a key seat on the shaft.

4. The method according to claim 1, wherein the assembling step comprises the sub-step of attaching a sleeve onto the shaft adjacent to the impeller; and the step of coating also comprises the step of coating a third predefined surface on the impeller and a fourth predefined surface on the shaft.

5. The method according to claim 4, wherein the third predefined surface is a portion of surface of the impeller designed to face the sleeve.

6. The method according to claim 4, wherein the fourth predefined surface is a portion of a lateral surface of the shaft designed to be arranged between the impeller and the sleeve.

7. The method according to claim 1, wherein the step of plating is performed by electroless nickel plating.

8. The method according to claim 1, wherein the coating step is performed by spraying the predefined surfaces.

9. The method according to claim 1, wherein the step of coating is performed by spraying the predefined surfaces with a cold spray.

10. The method according to claim 9, wherein the cold spray comprises particles of a nickel-based alloy or of stainless steel.

11. The method according to claim 1, wherein the step of coating is performed by spraying the predefined surfaces with a thermal spray.

12. The method according to claim 1, wherein the step of coating is performed by electroplating.

13. The method according to claim 12, wherein the electroplating is performed by electrolytic chromium or nickel.

14. An impeller-shaft assembly treated by the method for preventing corrosion of an impeller-shaft assembly of a turbomachine, the method comprising
assembling an impeller on a shaft in order to define an impeller-shaft assembly;
plating the assembly by inserting the assembly into a plating bath; and
coating at least a first predefined surface on the impeller and a second predefined surface on the shaft,
wherein the coating step is performed before the assembling step.

15. A turbomachine comprising the impeller-shaft assembly for preventing corrosion of an impeller-shaft assembly of a turbomachine, the method comprising
assembling an impeller on a shaft in order to define an impeller-shaft assembly;
plating the assembly by inserting the assembly into a plating bath; and
coating at least a first predefined surface on the impeller and a second predefined surface on the shaft,
wherein the coating step is performed before the assembling step.

16. The impeller shaft assembly according to claim 14, wherein the first predefined surface is a surface of a key slot on the impeller for attaching the impeller to the shaft.

17. The impeller shaft assembly according to claim 14, wherein the second predefined surface is the surface of a key seat on the shaft.

18. The impeller shaft assembly according to claim 14, wherein the assembling step comprises the sub-step of attaching a sleeve onto the shaft adjacent to the impeller; and the step of coating also comprises the step of coating a third predefined surface on the impeller and a fourth predefined surface on the shaft.

19. The impeller shaft assembly according to claim 14, wherein the step of plating is performed by electroless nickel plating.

20. The impeller shaft assembly according to claim 14, wherein the coating step is performed by spraying the predefined surfaces.
